(19) United States
(12) Patent Application Publication
(10) Pub. No.: US 2011/0264478 A1
(43) Pub. Date: Oct. 27, 2011

(54) ATTACHMENT DEVICE, INFORMATION COLLECTION DEVICE, AND METHOD FOR OBTAINING INFORMATION ABOUT REASONS FOR RETURN

(75) Inventor: Ryohaku Yukiyoshi, Kobe City (JP)

(73) Assignee: SANYO ELECTRIC CO., LTD., Moriguchi City (JP)

(21) Appl. No.: 13/091,573

(22) Filed: Apr. 21, 2011

(30) Foreign Application Priority Data
Apr. 21, 2010 (JP) 2010-097540

(51) Int. Cl. G06Q 10/00

(52) U.S. Cl. 705/7.11; 705/304

(57) ABSTRACT

An attachment device is provided to be attached to each product and includes an option storing unit which stores a plurality of options indicating reasons for return, and a selection receiving unit which presents each of the options so as to guide a user to select one of the options as a reason for return of the product. The device obtains information specifying the selected one of the options as return reason information.

### CROSS-REFERENCE TO RELATED APPLICATIONS

This nonprovisional application claims priority under 35 U.S.C. §119(a) on Patent Application No. 2010-097540 filed in Japan on Apr. 21, 2010, the entire contents of which are hereby incorporated by reference.

### BACKGROUND OF THE INVENTION

1. Field of the Invention

The present invention relates to an attachment device that is provided to be attached to each product, an information collection device that collects information obtained by the attachment device, and a method for obtaining information about reasons for return.

2. Description of Related Art

Conventionally, various products mass-produced in a factory or the like are distributed as goods in markets. There are different distribution forms of products, and each product is usually passed to a purchaser of the product.

As to handling of a purchased product, there is a return policy in many cases, in which return of the product is allowed. Specific contents of the return policy are different, and there is a case where return of a product is allowed regardless whether the product is defective or not within a certain period from purchase date. For example, there is a case where return of a product is allowed by a subjective reason such that the purchaser does not like the design thereof

When return of a product is performed, the purchaser is usually repaid for the product. Therefore, for a person who wants to buy a product, such return policy is preferable because he or she can buy the product at ease. On the other hand, it is important for the manufacturer of the product to reduce the situations causing return of the product, as much as possible.

Return of a product usually occurs when the purchaser is not satisfied with the product for a certain reason. Therefore, the reason why the purchaser returns the product (hereinafter referred to as “reason for return”) is usually due to a certain situation where the product causes the purchaser to have a dissatisfaction (including a reason due to a personal taste).

Therefore, in order to reduce the situations causing return of the product as much as possible, it is important for the manufacturer of the product to grasp major reasons for return of existing products, and to consider to avoid the situation where return of the product occurs for the same reason for return, as much as possible (for example, to develop a new product so that the reason for return can be resolved). In order to grasp major reasons for return, it is necessary to obtain information indicating a tendency of reasons for return.

As a method for obtaining the information indicating a tendency of reasons for return, it is considered to ask the purchaser who returns the product to teach the reason for return. However, in this case, if the load on the purchaser increases, there is high probability that the cooperation of the purchaser cannot be obtained. Thus, it is difficult to obtain the information indicating a tendency of reasons for return. In addition, for the manufacturer, it is desirable that the load (manpower and cost) for obtaining the information indicating a tendency of reasons for return can be reduced as much as possible.

Note that if the reasons for return is limited to those due to the fact that the product is defective, it would be possible to estimate the reason for return by investigating the returned product. Otherwise, for example, in the case where the product has been returned for a subjective reason of the private purchaser, the reason for return cannot be estimated in the same manner. Depending on the country or the region where the return policy is valid, there are cases where many of the reasons for return are not based on the fact that the product is defective.

### SUMMARY OF THE INVENTION

An attachment device according to the present invention is provided to be attached to each product and includes an option storing unit which stores a plurality of options indicating reasons for return, and a selection receiving unit which presents each of the options so as to guide a user to select one of the options as a reason for return of the product, in which the device obtains information indicating the selected one of the options as return reason information.

In addition, an information collection device according to another aspect of the present invention is the information collection device that collects and processes the return reason information obtained by each of the attachment devices having the above-mentioned structure, and counts the number of products returned with the reason for return individually for each type of the reasons for return included in the options based on the collected return reason information.

In addition, a method for obtaining information about reasons for return according to the present invention includes a first step of providing the attachment devices having the above-mentioned structure to a plurality of products, respectively, a second step of guiding a purchaser of the product to select one of the options by using the attachment device so as to obtain the return reason information, and a third step of collecting the return reason information obtained by the attachment device provided to each of returned products by using an information collection device.

### BRIEF DESCRIPTION OF THE DRAWINGS

FIG. 1 is an explanatory diagram of an attachment device and an information collection device according to an embodiment of the present invention.

FIG. 2 is a block diagram of a product according to the embodiment of the present invention.

FIG. 3 is a block diagram of an attachment device according to the embodiment of the present invention.

FIG. 4 is an explanatory diagram of an option table.

FIG. 5 is a flowchart of operation of the attachment device.

FIG. 6 is an explanatory diagram of a screen display concerning reception operation of reason for return.

FIG. 7 is an explanatory diagram of a screen display concerning reception operation of reason for return.

FIG. 8 is an explanatory diagram of a screen display concerning reception operation of reason for return.

FIG. 9 is an explanatory diagram of a screen display concerning reception operation of reason for return.

FIG. 10 is an explanatory diagram of a screen display concerning reception operation of reason for return.

FIG. 11 is a block diagram of the information collection device according to the embodiment of the present invention.

FIG. 12 is an explanatory diagram of a return reason accumulation table.

FIG. 13 is a flowchart of operation of the information collection device.

FIG. 14 is a flowchart of a method for obtaining information indicating a tendency of reasons for return.

### DETAILED DESCRIPTION OF THE PREFERRED EMBODIMENTS

As an embodiment of the present invention, there will be described a method for obtaining information indicating a tendency of reasons for return of one type of products mass-produced in a factory (hereinafter, referred to as an “investigation target type” for convenience sake), and devices that are used for realizing the method, as examples. Note that there are various forms of classification of types (about a range of the same type to be regarded). In this embodiment, one type of image display equipment that displays images is exemplified as the investigation target type.

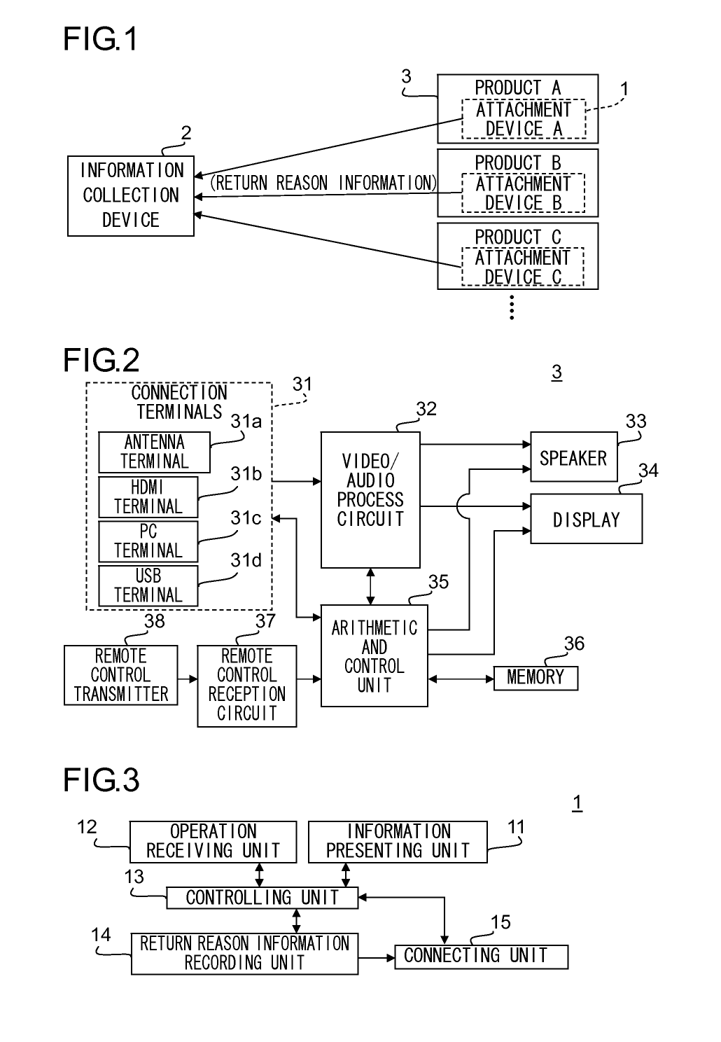

In the method for obtaining information indicating a tendency of reasons for return according to this embodiment, an attachment device and an information collection device are used. First, an outline of these devices will be described with reference to FIG. 1.

As illustrated in FIG. 1, an attachment device 1 is provided to be attached to each of products 3 of the investigation target type. Note that a form of attaching the attachment device 1 to the product 3 can be selected from various forms as long as the product 3 is accompanied by the attachment device 1 when the product 3 is transported and distributed.

For example, the attachment device 1 and the product 3 may be formed as one unit, or they may be formed separated and then the attachment device 1 is attached to the product 3. In addition, the case where the product 3 has a function as the attachment device 1 is regarded as one form of attaching the attachment device 1 to the product 3. As described later in detail, in this embodiment, the product 3 has a function as the attachment device 1.

The attachment device 1 is supposed to be passed to a purchaser when the product 3 is purchased. Then, at the stage when the attachment device 1 is passed to the purchaser, it becomes possible to perform an operation for receiving an input of reason for return by a user (hereinafter referred to as a “return reason receiving action”), so that information about reason for return of the product 3 (return reason information) can be obtained. Contents of the return reason receiving action will be described later in detail.

An information collection device 2 is under management of a manufacturer of the product 3, so that the manufacturer can use it freely. As described later, the information collection device 2 collects return reason information from the attachment device 1 that attaches to each returned product 3 and provides the user with various types of information based on the collected return reason information.

### [About Structure of Product]

Here, a specific structure of the product 3 (image display equipment) will be described with reference to FIG. 2. As illustrated in this diagram, the product 3 includes connection terminals 31, a video/audio process circuit 32, a speaker 33, a display 34, an arithmetic and control unit 35, a memory 36, a remote control reception circuit 37, and a remote control transmitter 38.

The connection terminals 31 include various types of terminals that are used for connection to other devices. More specifically, the connection terminals 31 include an antenna terminal 31a that is used for connection to an antenna for receiving television broadcasting, an HDMI terminal 31b that is used for connection to a recording unit or the like, a PC terminal 31c that is used for connection to a personal computer, and a universal serial bus (USB) terminal 31d that is used for connection to various devices such as the information collection device 2.

The video/audio process circuit 32 performs necessary processing on the signal supplied via one of the connection terminals 31 and generates a sound signal and an image signal (or one of the signals) so as to deliver the signals to the poststage. For example, when a television broadcasting signal is supplied via the antenna terminal 31a, the video/audio process circuit 32 performs a tuning process and a demodulating process on the signal so as to generate a sound signal and an image signal concerning contents of the television program.

The speaker 33 generates sound based on the sound signal received from the video/audio process circuit 32 or the arithmetic and control unit 35. In addition, the display 34 displays an image based on the image signal received from the video/audio process circuit 32 or the arithmetic and control unit 35.

The arithmetic and control unit 35 is constituted of a CPU, for example, and performs various arithmetic processes and controls of individual units so that the product 3 can work as the image display equipment. The memory 36 is constituted of a flash memory, for example, and stores various types of information in a nonvolatile and rewritable manner. The memory 36 is accessible by the arithmetic and control unit 35.

The remote control reception circuit 37 receives a remote control signal transmitted from the remote control transmitter 38 and sends information indicated by the signal to the arithmetic and control unit 35. In addition, the remote control transmitter 38 is provided with button switches and the like to be operated by the user and generates the remote control signal indicating operation content, which is transmitted to the remote control reception circuit 37 via wireless. Thus, the user can remote control the product 3.

The product 3 has the structure described above and performs image display and sound output based on the input signal. In addition, various performance states such as a sound level of the speaker 33 are determined responding to the remote controller operation using the remote control transmitter 38.

### [About Structure of Attachment Device]

Next, a structure of the attachment device 1 will be described with reference to FIG. 3. As illustrated in this diagram, the attachment device 1 is equipped with functional units including an information presenting unit 11, an operation receiving unit 12, a controlling unit 13, a return reason information recording unit 14, and a connecting unit 15.

The information presenting unit 11 stores various types of information to be presented to the user when the above-mentioned return reason receiving action is performed, and has function of presenting the information. In this embodiment, the presentation of the information is realized by the image display. However, it is possible to realize it by sound output or the like.

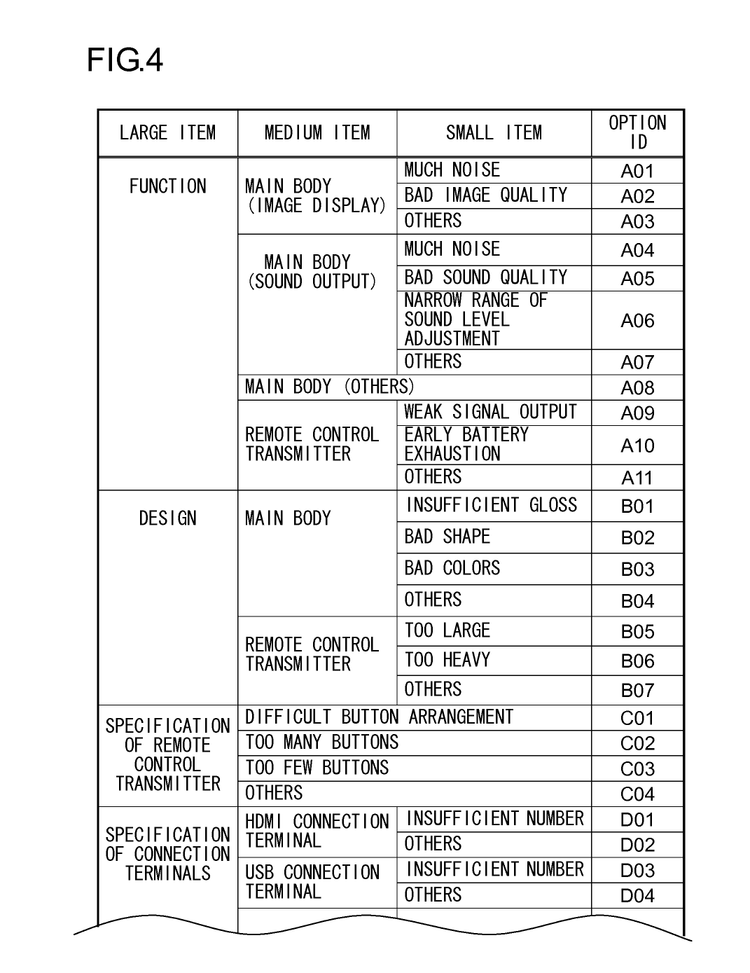

Note that the information recorded in the information presenting unit 11 includes an option table as illustrated in FIG. 4. This option table includes information of a plurality of options indicating reasons for return that are prepared in advance and option IDs thereof (such as a number for distinguishing from other options).

In addition, the options in the option table may be arranged in a tree structure as illustrated in FIG. 4, in which the contents thereof are narrowed in order of a large item, a medium item, and a small item. For example, the option having an option ID of “B05” is related to “design”, and is further related to the “remote control transmitter”, and further indicates “being too large”. In other words, this option indicates the reason for return meaning that the remote control transmitter 38 of the product 3 is too large (and therefore the design thereof is not good).

Note that each option included in the option table indicates each type of reason for return except for the reason that the product is defective among reasons for return. However, contents and form of the options are not limited to those described above. It is possible that each option is not split into elements of items. How to use the option table will be described and clarified later.

The operation receiving unit 12 has a function of receiving operation for inputting information by the user when the return reason receiving action is performed. In addition, the controlling unit 13 has a function of controlling individual units of the attachment device 1 so that the return reason receiving action and the like are performed appropriately. Note that a main operation performed by the attachment device 1 will be described later.

The return reason information recording unit 14 has a function of recording and storing the obtained return reason information in a nonvolatile manner. In addition, the connecting unit 15 has a function of enabling connection to the information collection device 2 via a connection line based on the USB standard.

The individual functional units of the attachment device 1 described above are embodied by elements of the product 3. Specifically, the information presenting unit 11 is embodied mainly by the display 34 and the arithmetic and control unit 35. In addition, the operation receiving unit 12 is embodied mainly by the arithmetic and control unit 35, the remote control reception circuit 37, and the remote control transmitter 38. In addition, the controlling unit 13 is embodied mainly by the arithmetic and control unit 35. In addition, the return reason information recording unit 14 is embodied mainly by the arithmetic and control unit 35 and the memory 36. In addition, the connecting unit 15 is embodied mainly by the USB terminal 31d and the arithmetic and control unit 35.

In this way, in this embodiment, the product 3 has the function as the attachment device 1. In other words, elements of the product 3 also work as elements of the attachment device 1. Therefore, it is possible to reduce cost increase or increase in the number of elements of the product 3 due to the attachment device 1 that is added, as much as possible.

### [About Operation of Attachment Device]

Next, an operation performed by the attachment device 1 will be described with reference to the flowchart illustrated in FIG. 5. Note that the operation performed by the attachment device 1 can be regarded as an operation performed by the product 3 itself

The attachment device 1 always monitors an operation of instructing start of a predetermined action in the operation receiving unit 12 (Step S10). This operation is a special operation for controlling the attachment device 1 to start the return reason receiving action. In addition, this operation is supposed to be performed by the purchaser in a situation where the purchaser wants to return the product 3.

Therefore, the operation is preferably adapted not to be performed in error when the product 3 is in normal use. Therefore, the operation is preferably complicated to a certain extent, which includes simultaneous pressing of a plurality of specific buttons of the remote control transmitter 38, for example.

When the operation of instructing the start of action is performed (Y in Step S10), the attachment device 1 starts the return reason receiving action. The return reason receiving action is mainly aimed to obtain the return reason information specifying the reason for return. The return reason receiving action is performed in the procedure as described below.

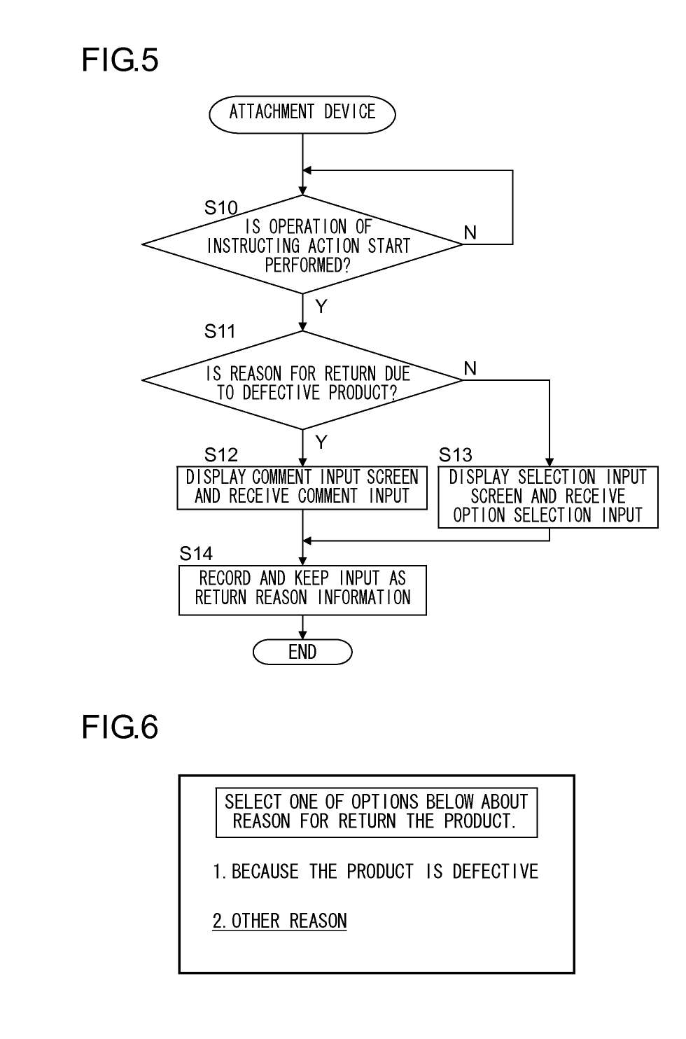

First, the attachment device 1 receives a selection input performed by the user about whether or not the reason for return is due to a reason that the product 3 is defective (Step S11). More specifically, as illustrated in FIG. 6, the information presenting unit 11 displays the option of “because the product is defective” (reason due to that the product 3 is defective) and the option of “other reason” (reason not due to that the product 3 is defective), so as to guide the user to select one of them. In this case, the user can selects and inputs one of them by operating the operation receiving unit 12.

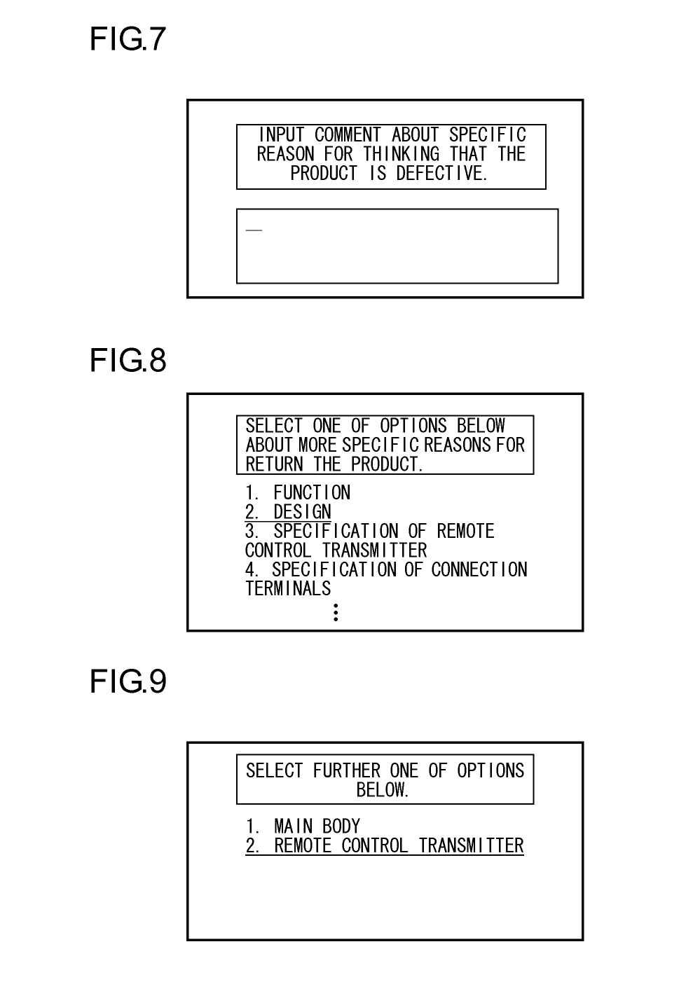

Then, if the option of “because the product is defective” is selected (Y in Step S11), the attachment device 1 receives a comment input by the user about a specific reason for return. More specifically, the information presenting unit 11 displays a comment input screen as illustrated in FIG. 7 (for example, a screen for receiving one by one character input so as to receive the comment input) and receives the comment input expressing a specific reason for return (Step S12). In this case, the user can input the comment by operating the operation receiving unit 12.

On the other hand, if the option of “other reason” is selected (N in Step S11), the attachment device 1 receives a selection input by the user about a specific reason for return. More specifically, the information presenting unit displays a selection input screen as illustrated in FIG. 8 (a screen for displaying options and receiving a selection of one of the options), and receives the selection input of the option expressing a specific reason for return (Step S13).

Note that the options displayed in the selection input screen are included in the option table stored in the information presenting unit 11. In addition, the display of the options is performed in the manner as described below. First, elements of the large item are displayed, and then elements of the medium item are displayed responding to a selection input by the user. Further, elements of the small item are displayed responding to a selection input by the user. Thus, while keeping the reason for return in mind, the user sequentially selects elements closer to the reason for return. Thus, the user can finally select one option.

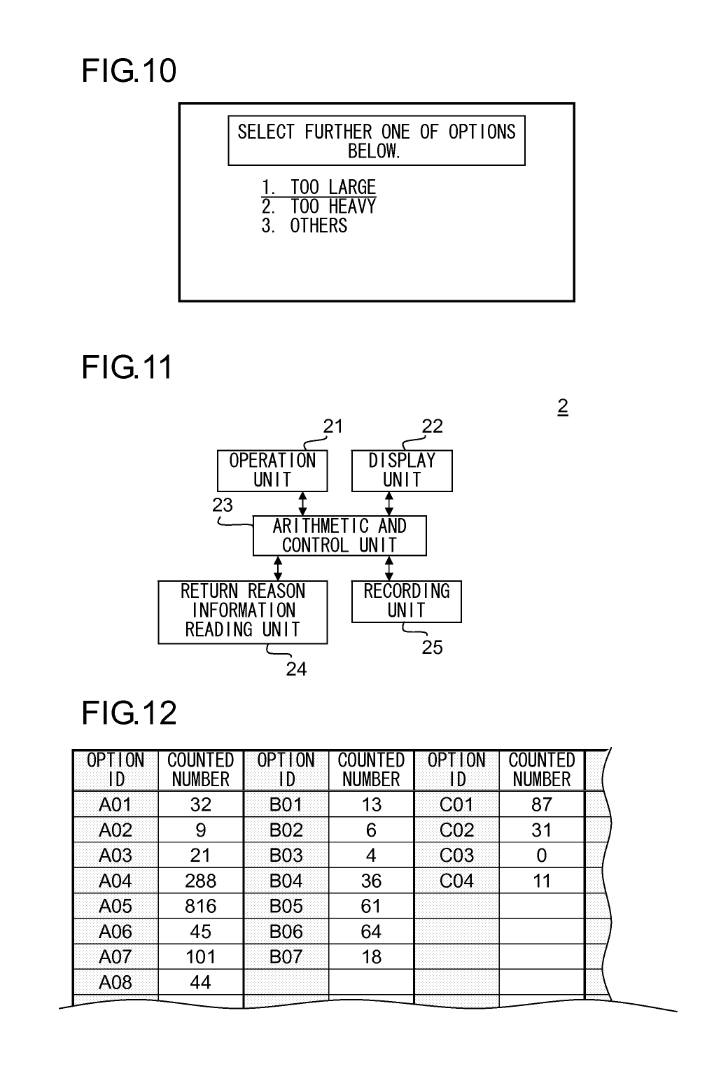

For example, it is supposed that the reason for return is that the remote control transmitter 38 of the product 3 is too large (and therefore the design thereof is not good). When the screen illustrated in FIG. 8 (expressing elements of the large item) is displayed, the user selects the element of “design”. After that, when the screen illustrated in FIG. 9 (expressing elements of the medium item concerning “design”) is displayed, the user selects the element of “remote control transmitter”. After that, when the screen illustrated in FIG. 10 (expressing elements of the small item concerning “remote control transmitter”) is displayed, the user selects the element of “too large”. When the selections up to this stage have been performed, it means that the option having the option ID of B05 is selected by the user.

When the information of specific reason for return is input via the comment input screen or the selection input screen, the return reason information recording unit 14 records and keeps the input information as the return reason information (Step S14). If the comment is input via the comment input screen, the comment is regarded as the return reason information. On the other hand, if the option is selected via the selection input screen, the option ID of the selected option is regarded as the return reason information. In this case, the return reason information can be said to be information specifying the selected one of the plurality of options indicating the reasons for return.

### [About Structure of Information Collection Device]

Next, a structure of the information collection device 2 will be described with reference to FIG. 11. As illustrated in this diagram, the information collection device 2 includes an operation unit 21, a display unit 22, an arithmetic and control unit 23, a return reason information reading unit 24, and a recording unit 25. As the information collection device 2, for example, a personal computer owned by the manufacturer of the product 3 is used.

The operation unit 21 has a user interface for receiving an operation by the user, which sends the information indicating the operation to the arithmetic and control unit 23. Thus, the arithmetic and control unit 23 can perform various processes on which user's intention is reflected.

The display unit 22 includes a display and displays various types of information according to an instruction of the arithmetic and control unit 23. The arithmetic and control unit 23 performs various arithmetic processes and control processes that are necessary for the information collection device 2 to perform a predetermined action. Note that main actions performed by the information collection device 2 will be described later.

The return reason information reading unit 24 also includes a USB connection terminal, through which it can be connected to the attachment device 1 (connecting unit 15). The return reason information reading unit 24 reads out the return reason information recorded in the attachment device 1 (return reason information recording unit 14) when it is connected to the attachment device 1. Reading of the return reason information is automatically performed by the return reason information reading unit 24 when the connection to the attachment device 1 is detected, for example.

When the return reason information reading unit 24 is connected to a plurality of attachment devices 1 one by one or simultaneously, it reads the return reason information from each of the attachment devices 1. Thus, the information collection device 2 can collect each of the return reason information obtained by each of the attachment devices 1, via information transmission using the connection line of the USB standard. However, it is possible to adopt other various forms as the connection form between the attachment device 1 and the information collection device 2.

The recording unit 25 records various types of information in a nonvolatile and rewritable manner. The recording unit 25 can be accessed by the arithmetic and control unit 23, so that the return reason information pieces read by the return reason information reading unit 24 are stored one by one.

In addition, the information recorded by the recording unit 25 includes a return reason accumulation table as illustrated in FIG. 12. This return reason accumulation table includes the counted number of reading the return reason information of each option ID used in the above-mentioned option table (see FIG. 4). This counted number can be said to be a result of counting the number of the returned product 3 with the reason for return of each type included in the options.

### [About Action of the Information Collection Device]

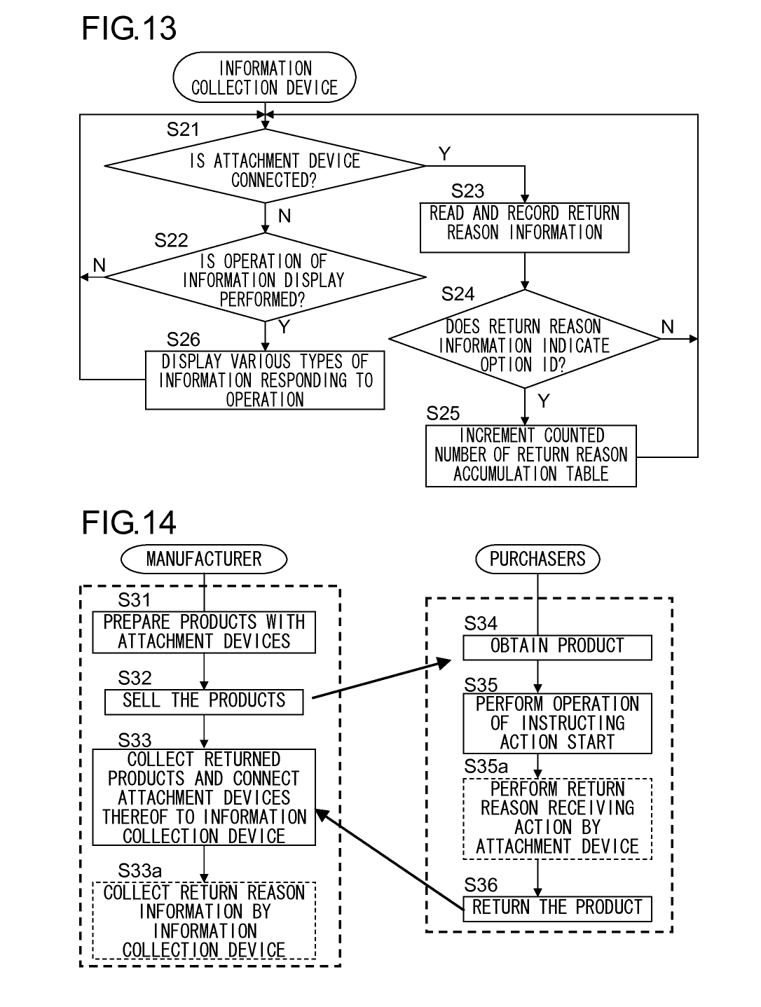

Next, an action performed by the information collection device 2 will be described with reference to the flowchart illustrated in FIG. 13.

Via the return reason information reading unit 24, the information collection device 2 monitors whether or not the attachment device 1 is connected (Step S21) and whether or not the operation of the information display is performed by the operation unit 21 (Step S22). When the attachment device 1 is connected (Y in Step S21), the information collection device 2 reads the return reason information recorded and kept in the attachment device 1, so as to record the same in the recording unit 25 (Step S23).

If the read return reason information indicates the option ID (Y in Step S24), the counted number corresponding to the option ID in the return reason accumulation table is incremented (Step S25). Thus, the number of returned products with the reason for return of each type included in the options of the option table is counted.

After the action in Step S25 is performed, the action in Step S21 is repeated. Note that if the return reason information does not indicate the option ID (N in Step S24), namely if the return reason information indicates a comment or the like, the incrementing action is not performed, and the action of Step S21 is repeated.

On the other hand, when the operation of the information display is performed (Y in Step S22), the information collection device 2 displays various types of information corresponding to the operation via the display unit 22 (Step S26). As the displayed information, there is a list of comments indicated by the return reason information pieces stored in the recording unit 25, or contents of the return reason accumulation table. Thus, the manufacturer can see the displayed various types of information as necessary, so that the information can be utilized for developing a new product.

Note that the contents of the return reason accumulation table may be displayed in a form of a table, a graph, or the like. Thus, the manufacturer can grasp the contents of the return reason accumulation table more easily. After the action in Step S26 is performed, the action of Step S21 is repeated.

By the above-mentioned series of actions, the contents of the return reason accumulation table are updated every time when the return reason information indicating the option ID is read out, so that the latest state thereof is maintained. In addition, the contents of the return reason accumulation table indicates the reason for return with which the products of the investigation target type are mostly returned (namely, a tendency of reasons for return).

For example, according to the return reason accumulation table in the state illustrated in FIG. 12, it is understood that the products are mostly returned with the reason for return corresponding to the option having the option ID of “A05”, namely the reason for return indicating “bad quality of sound output”. In this case, the manufacturer can develop a new product having improved quality of sound output so that products are not returned with the same reason for return after that. In this way, the collected return reason information can be fed back to the manufacturer, so as to be reflected on development of a new product or the like.

### [About Method of Obtaining Information Indicating Tendency of Reasons for Return]

The manufacturer of the product 3 can use the attachment device 1 and the information collection device 2 so as to obtain information indicating a tendency of reasons for return about the investigation target type. A method for obtaining the information will be described with reference to the flowchart illustrated in FIG. 14.

First, the manufacturer mass produces the product 3 equipped with the attachment device 1. This can be regarded as preparing a plurality of products 3 equipped with the attachment device 1 (Step S31). Then, the manufacturer sells each of the products 3 with the attachment device 1 (Step S32). Each of the sold products 3 is purchased by each of the purchasers (Step S34).

Then, it is supposed that some of the purchasers return the purchased products 3 because of certain reasons for return. The purchaser who is going to return the purchased product performs the above-mentioned operation of instructing the start of action by the attachment device 1 (Step S35). Note that various forms may be adopted as the method for guiding the purchaser who is going to return the product to perform the operation.

For example, it is possible to describe in an instruction manual packaged with the product 3 so as to guide him or her to perform the operation, like a message saying “When you want to return this product, please do the operation A (that indicates the operation of instructing the start of action) so as to input your reason for return according to the screen display.” In addition, when the purchaser who is going to return the product makes an inquiry to the manufacturer (for example, an inquiry by telephone like dial 800, the manufacturer may ask the purchaser to perform the operation.

When the operation of instructing the start of action is performed, the attachment device 1 performs the above-mentioned return reason receiving action (Step S35a). Accompanying this, the purchaser who is going to return the product inputs the reason for return of the product 3. As a result, the attachment device 1 obtains the return reason information. After that, the product 3 is returned from the purchaser to the manufacturer (Step S36).

The manufacturer collects the returned products 3. When the returned products 3 are collected, the attachment devices 1 having the return reason information are also collected. Then, the manufacturer connects the attachment device 1 to the information collection device 2 (Step S33).

The information collection device 2 reads and collects the return reason information recorded and kept in each of the connected attachment device 1 (Step S33a). Note that the forms of collecting the return reason information by the information collection device 2 may include the form in which the return reason information is directly collected from the attachment device 1 as well as other forms in which the return reason information is indirectly collect via a recording medium or a network, for example.

In addition, the information collection device 2 may be able to collect the return reason information from a plurality of types of products. In this case, it is preferable to provide the return reason accumulation table and the like individually for each type so that the information indicating a tendency of reasons for return is obtained individually for each type.

As described above, when the return reason information is collected, the information indicating a tendency of reasons for return (the return reason accumulation table and the like) is obtained. Therefore, the manufacturer can use the information collection device 2 for obtaining the information indicating a tendency of reasons for return so as to utilize the information for developing a new product or the like.

### [Others]

As described above, the attachment device 1 according to this embodiment includes a functional unit that is provided to be attached to each product 3 and stores an option table (a plurality of options indicating reasons for return), and a functional unit that presents each of the options so as to guide the user to select one of the options as the reason for return of the product 3, in which the device obtains information specifying the selected one of the options as return reason information.

Therefore, according to the attachment device 1, after the purchaser who returns the product inputs the reason for return with the attachment device 1, the manufacturer of the product collects the attachment device 1 storing the reason for return and collects the return reason information from each attachment device, so that the information indicating a tendency of reasons for return can be obtained.

In addition, according to the attachment device 1, the input of the reason for return to the attachment device 1 can be realized only by selecting the presented option. Therefore, it is possible to reduce a load on the purchaser comparing with the case where the purchaser is required to input sentences or comments.

However, as the form of receiving the input of the reason for return, it is possible to use a form in which the purchaser inputs comments together with the form in which the options are selected. If the form in which comments are input is adopted, the load on the purchaser may be increased compared with the case where the options are selected, but the manufacturer can save the labor of preparing the options.

Note that it is considered to be particularly important in this embodiment to obtain the information indicating a tendency of reasons for return about reasons for return that do not indicate that the product is defective. Therefore, in this embodiment, if the reason for return is due to the fact that the product 3 is defective, the form in which comments are input is adopted. Otherwise, the form in which options are selected is adopted (see the action in Step S11).

Thus, if the reason for return is not due to the fact that the product 3 is defective, it is expected that the purchaser may easily cooperate for inputting the reason for return. As a result, the manufacturer can easily and appropriately investigate the reasons for return when the products have been returned though they are not defective. In addition, even if the reason for return is due to the fact that the product 3 is defective, the attachment device 1 receives the input of the reason for return, so that the reason for return can be investigated.

Note that when the options indicating the reasons for return are determined, it is preferable to suppose many situations that would be reasons for return in the position of purchasers so as to adopt them as options. Thus, it is possible to increase the probability that the purchaser can select the reason for return appropriately, so that the manufacturer can obtain useful return reason information.

In addition, according to the attachment device 1, collection of the attachment device 1 storing the reason for return is realized by collection of the returned products 3. Therefore, the load on the manufacturer can be reduced compared with the case where the work for collecting the attachment devices 1 is performed separately from collection of the products 3.

In addition, the information collection device 2 according to this embodiment collects and processes the return reason information obtained by each of the attachment devices 1, and counts the number of products individually for each type of reason for return included in the options based on the collected return reason information. Therefore, according to the information collection device 2, the manufacturer can easily grasp a tendency of reasons for return by referring to a result of the count.

In addition, the method for obtaining information indicating a tendency of reasons for return according to this embodiment includes a step of providing the attachment devices 1 to a plurality of products 3 (see Step S31), a step of guiding a purchaser of the product 3 to select one of the options by using each of the attachment devices 1 so as to obtain the return reason information (see Step S35a), and a step of collecting the return reason information obtained by the attachment device 1 provided to each of returned products 3, by using an information collection device 2 (see Step S33a).

According to the method, using the attachment device 1 and the information collection device 2, the information indicating a tendency of reasons for return can be obtained while reducing loads on the manufacturer and on the purchaser as much as possible.

In addition, in this embodiment, the image display equipment (an electric product) is described as an example of the product, but the type of the product to which the present invention can be applied is not limited to this product. The present invention can be applied to various products to which the return policy is applied.

In addition, in the description described above, a purchaser of the product 3 is mentioned as a typical example of a person who inputs the reason for return to the attachment device 1, but other person may input. Similarly, a manufacturer of the product 3 is mentioned as a typical example of a person who obtains the information indicating a tendency of reasons for return, but other person may obtain.

As described above, the embodiment of the present invention is described, but the present invention is not limited to this embodiment. In addition, the embodiment of the present invention can be modified variously unless deviating from the spirit of the present invention.

According to the attachment device of the present invention, after the purchaser or the like who returns the product inputs the reason for return with the attachment device, the manufacturer or the like of the product collects the attachment device storing the reason for return and collects the return reason information from each attachment device, so that the information indicating a tendency of reasons for return can be obtained. Further, according to the attachment device, the input of the reason for return to the attachment device is realized only by selecting presented options. Therefore, the load on the purchaser or the like can be reduced as much as possible. In addition, according to the attachment device, the collection of the attachment device storing the reason for return is realized by collection of the returned products. Therefore, the load on the manufacturer or the like can also be reduced as much as possible.

In addition, according to the information collection device of the present invention, the manufacturer or the like of the product can easily grasp a tendency of reasons for return by referring to a result of the count. In addition, according to the method for obtaining information of the present invention, it is possible to obtain the information indicating a tendency of reasons for return while reducing the load on the manufacturer of the product and on the purchaser or the like.

What is claimed is:

1. An attachment device provided to be attached to each product, the device comprising:
an option storing unit which stores a plurality of options indicating reasons for return; and
a selection receiving unit which presents each of the options so as to guide a user to select one of the options as a reason for return of the product, wherein
the device obtains information specifying the selected one of the options as return reason information.

2. An information collection device that collects and processes the return reason information obtained by each of the attachment devices according to claim 1, wherein the information collection device counts the number of products returned with the reason for return individually for each type of the reasons for return included in the options based on the collected return reason information.

3. A method for obtaining information indicating a tendency of reasons for return, the method comprising:
a first step of providing the attachment devices according to claim 1 to a plurality of products, respectively;
a second step of guiding a purchaser of the product to select one of the options by using the attachment device so as to obtain the return reason information; and
a third step of collecting the return reason information obtained by the attachment device provided to each of returned products, by using an information collection device.

4. A method according to claim 3, wherein the information collection device collects and processes the return reason information obtained by each of the attachment devices, and counts the number of returned products with the reason for return individually for each of types of reasons for return included in the options based on the collected return reason information.

5. A method according to claim 3, wherein each of the reasons for return included in the options are not due to the fact that the product is defective.

6. A method according to claim 4, wherein each of the reasons for return included in the options are not due to the fact that the product is defective.

7. A method according to claim 3, wherein
each of the attachment devices and the information collection device are connected to each other via a connection line of the USB standard, and
collection of the return reason information is realized by information transmission using the connection line.

8. A method according to claim 4, wherein
each of the attachment devices and the information collection device are connected to each other via a connection line of the USB standard, and
collection of the return reason information is realized by information transmission using the connection line.

9. A method for obtaining information indicating a tendency of reasons for return of a predetermined type of electric products by using an information collection device, wherein
each of the electric products comprises
an option storing unit which stores a plurality of options indicating reasons for return,
a selection receiving unit which presents each of the options so as to guide a user to select one of the options as a reason for return of the electric product, and
an information obtaining unit which obtains information specifying the selected one of the options as return reason information,
the information collection device collects the return reason information and counts the number of returned electric products with the reason for return individually for each type of the reasons for return included in the option, based on the collected return reason information, and
the method comprises
a step of guiding a purchaser of the electric product to select one of the options by the electric product so that the return reason information is obtained, and
a step of collecting the return reason information obtained by each of the returned electric products, by the information collection device.
